(19) United States
(12) Patent Application Publication
(10) Pub. No.: US 2019/0020854 A1
(43) Pub. Date: Jan. 17, 2019

(54) Method and system for recording online tutoring

(71) Applicants: Bryce Jonathan Di Geronimo, San Ramon, CA (US); Matthew Joseph Di Geronimo, San Francisco, CA (US); Ryan Thomas Di Geronimo, Seattle, WA (US)

(72) Inventors: Bryce Jonathan Di Geronimo, San Ramon, CA (US); Matthew Joseph Di Geronimo, San Francisco, CA (US); Ryan Thomas Di Geronimo, Seattle, WA (US)

(21) Appl. No.: 15/649,636

(22) Filed: Jul. 13, 2017

(51) Int. Cl. H04N 7/15; G09B 5/06; G09B 5/14; G09B 5/12; H04N 5/76; H04L 29/06

(52) U.S. Cl. CPC H04N 7/155; G09B 5/065; G09B 5/14; H04N 7/147; H04N 5/76; H04L 65/1066; G09B 5/12

(57) ABSTRACT

Prior embodiments for methods and apparatuses for online tutoring are disclosed. A method of recording a tutoring session is disclosed. Recording a tutoring session includes recording what was written on the whiteboard technology, which will include extemporaneous written explanations, what was said via audio, and the ability to see the tutor. In an embodiment, recording of a tutoring session enables a tutoring company to monitor the tutors and review the recordings for quality control purposes. In another embodiment, the recordings are made available for reference at a later date for students who are being tutored. Students can download the recordings of the sessions, which they can then refer to at a later date to go over previous topics covered. In another embodiment, parents of the students being tutored are supplied with access to the recorded video of their child being tutored.

### CROSS REFERENCE TO RELATED APPLICATIONS

This application claims priority from U.S. Provisional Patent Application No. 62/493,653, entitled “Method and System for Recording Online Tutoring,” filed Jul. 13, 2016, which is hereby incorporated by reference as if set forth in full in this application for all purposes.

### BACKGROUND

The Online tutoring market is growing quickly and according to London based tech research firm Technavio, the online tutoring industry is expected to grow a compounded annual growth rate of 12.75% between 2017-2021. According to Technavio, growth in the online tutoring market can be attributed to a number of factors which include technology expanding the market by allowing more tutors to reach out to a bigger audience of students, information and communication technology having improved virtual classrooms are becoming more readily available across the world, and the rise in private, online tutoring services as virtual classrooms have become more common.

Online tutoring enjoys a number of benefits over conventional tutoring in which the student and the tutor are collocated. These benefits include efficiency, the increased availability of tutors, and the access to a broader pool of tutors for the students and a broader pool of students for the tutors.

Although online tutoring has many benefits over conventional tutoring there are several legitimate concerns. One of these concerns is the ability of an online tutoring company to monitor how their tutor is behaving during an online tutoring session with a student.

It is desirable to have a method and system for addressing these concerns.

### SUMMARY

An embodiment includes a method of recording an online tutoring session. In an embodiment, after a student and tutor agree to an online tutoring session and join the online tutoring session the audio, video, and whiteboard technology of the online tutoring session will be recorded. A subsequent step after the recording of the online tutoring session enables the previously recorded online tutoring session to be replayed at a later time. In an embodiment, the student can review a previously recorded tutoring session. In another embodiment, the parent of the student can replay said previously recorded tutoring session to assess the quality and efficacy of the tutoring. In yet another embodiment, a business enterprise can use previously recorded online tutoring sessions for quality control purposes. In yet another embodiment, said business enterprise can make tutor ranking decisions based in part on review of recorded online tutoring sessions.

### BRIEF DESCRIPTION OF THE DRAWINGS

FIG. 1 illustrates an example of the workflow for how an online tutoring session is booked and recorded

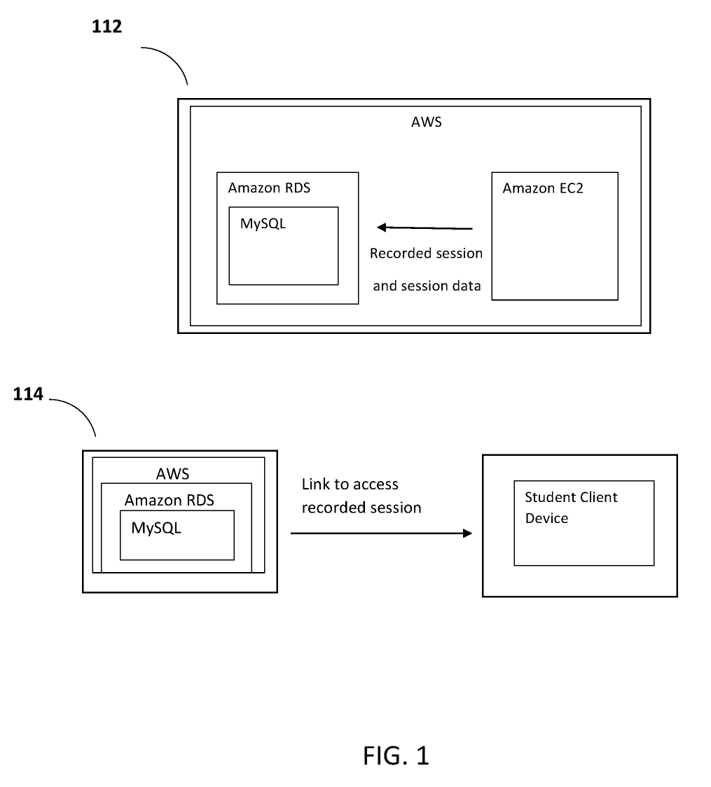

FIG. 2 illustrates the backend technologies that are integrated and ran on a server that are needed to set up, run, record, and make available online tutoring sessions

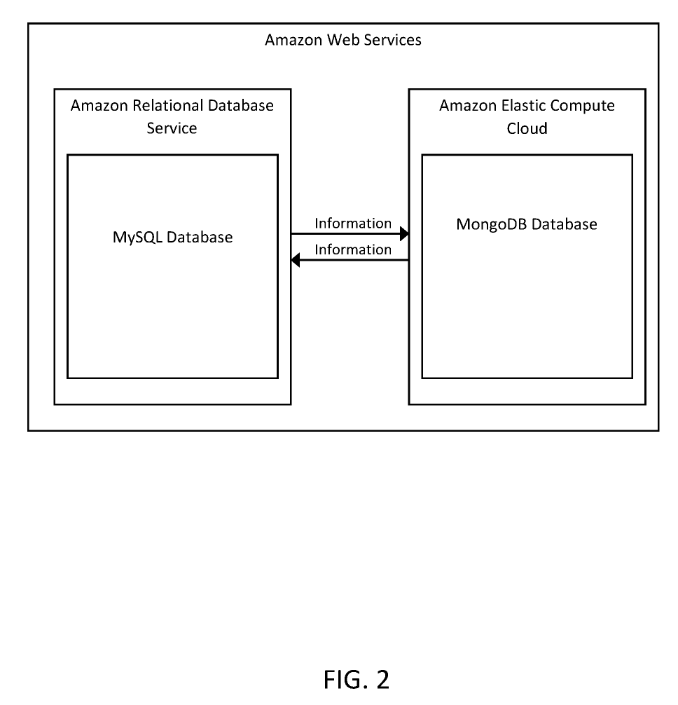

FIG. 3 illustrates an example of how an online tutoring session would appear to a student and tutor

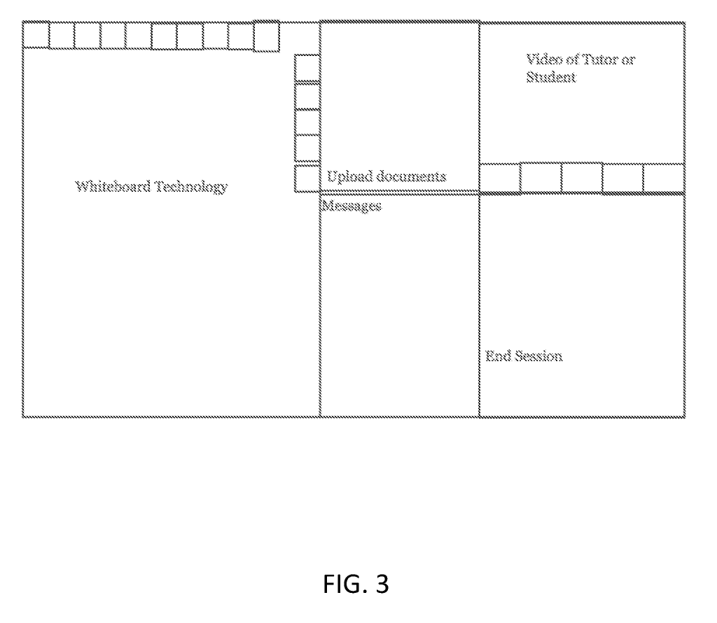

FIG. 4 illustrates an example of where and how the information of a recorded online tutoring session is made available for download and review

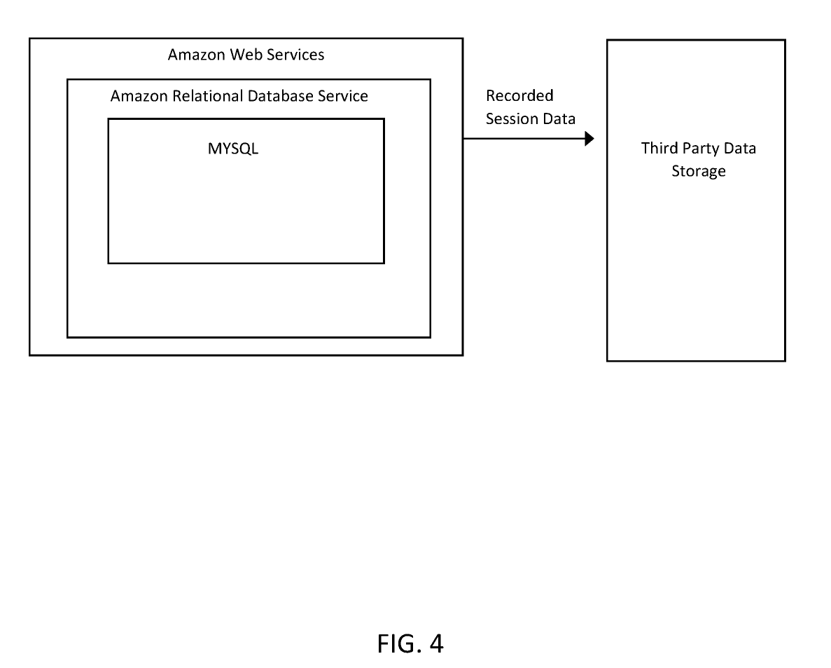

### DETAILED DESCRIPTION

While the online tutoring market is small, however, it is expected to grow at a substantial rate at a compounded annual growth rate of 12.75% from 2017-2021 according to London based tech research firm Technavio. Online tutoring conveys a number of benefits over conventional tutoring, however its implementation faces challenges.

Although online tutoring has a number of benefits over conventional tutoring there are several legitimate concerns. First, to be successful a tutoring company must maintain control over the quality of its tutors. One method is to solicit feedback from the students and assign a rating based on the average feedback. While useful, this method has its limitations. First, when a tutor has completed relatively few sessions, his/her rating is unduly influenced by a student's feedback. This may not be representative of the quality of the tutor's tutoring. Second, it does not provide an obvious means of recourse if poor feedback is given.

An additional concern is that of the appropriateness of the behavior of the tutor. While online tutoring is safer than in-person tutoring in the sense that the tutor and student are not in physical proximity to each other, it is advantageous to be able to ensure the tutoring is being conducted in a professional, wholesome manner.

Finally, parents of students who want to monitor the online tutoring session may not always be able to do so given their time restraints but these parents still want to be able to monitor to assess the efficacy of the tutoring, the quality of the tutor, their child's level of understanding, or their child's level of effort.

Given the growth in the online tutoring market, these issues will affect more students and tutors each year. It is desirable to have a method and system for addressing these concerns. A method and system of solving the above concerns is to record online tutoring sessions for review at a later time. Recording of online tutoring sessions for review at a later time is something that has not been appreciated in the online tutoring market. While the recordings of these tutoring sessions require significant storage, they convey great benefits. Benefits of recording online tutoring sessions and making them available for review at a later time include; students being able to review the recorded sessions for reinforcing their knowledge, allowing parents of the students to assess the tutor, allowing parents to assess the progress and/or effort of their child, allowing the business to control the quality of their tutors and/or in ratings of their tutors, and if complaints or poor ratings are given the recorded tutoring session can be reviewed to adjudicate.

The following definitions can be used to understand the method and system of the recording of an online tutoring session: A client device can be defined as any computer including but not limited to a; desktop, laptop, or mobile device such as an iPad, tablet, and phone. A server can be defined as a computer system or program that utilizes http protocol to send files which the user will receive as web pages in response to the users' request. A user can be defined as a student or tutor that is utilizing a client device. An email service provider (ESP) can be defined as a company that offers email marketing services. In an embodiment, typical functions of an ESP include but are not limited to; a program, application, or daemon that allows its users to send out emails to selected targets, ability to create templates, and statistics of email campaigns that are sent out through the ESP. A typical online tutoring session contains at least one of the following; audio, video of the tutor, video of the student, and a whiteboard technology showing the assignment and the work associated with explaining it or solving it. Using these technologies, online tutoring can be made efficient.

The process of how an online tutoring session is recorded and made available at a later time is as follows:

In an embodiment, a student starts by using a client device to log in or create a student account on the Online Tutoring website. In an embodiment, the online tutoring website is STEM Sensei's website. In an embodiment, once the student is logged in to his/her student account the student will access the online tutoring service. In an embodiment, when the student selects the online tutoring service the server will provide a list of the tutors that are in a tutor database.

In an embodiment, a student will be able to sort the list of tutors that the server is showing to the student by selecting filters. Filters can be any attributes a student may care about when selecting a tutor, which can include but is not limited to, the subject a tutor is able to teach, hourly rate of the tutor, number of reviews by other students of a tutor, ratings of a tutor, whether the tutor is currently online, and the availability of a tutor.

In an embodiment, a student may select an online service other than Online Tutoring such as Homework Help and/or Lab Help that will allow the student to connect with tutors through completing an intake form that will be matched to tutors that fit the student's submitted criteria. In an embodiment, all Homework Help and/or Lab Help Online Tutoring sessions can be recorded and be made available to said student. In an embodiment, the recorded online tutoring session for Homework Help and/or Lab Help can also be made available to parents of said student. In an embodiment, the recorded online tutoring session for Homework Help and/or Lab Help will also be available to the tutoring company to help maintain quality control.

In an embodiment, once a student finds a tutor that he/she would like to work with the student is able to message the tutor.

In an embodiment, a tutor will log in to his/her tutor account and will respond to a student's message requesting a tutoring session.

In an embodiment, a student and tutor will work together to find a mutually convenient time to set up an online tutoring session. In an embodiment, once a student and tutor agree on a time for an online tutoring session the tutor will send over a session invite.

The databases, servers, and web hosting service play an essential role in the process of creating, making available and recording of online tutoring sessions. In an embodiment, a No Structured Query Language (NoSQL) database is used to store user accounts, details of resources, chat messages, and other files including but not limited to attachments and user images. This NoSQL database is hosted on a server. In an embodiment, the database is implemented with a My Structured Query Language (MySQL) database that resides on a relational database server. In an embodiment, the MySQL database is used but is not limited to; creating the session ID and storing all recorded session data. In an embodiment, the MySQL database resides on a server such as Amazon RDS. In an embodiment, the NoSQL database used is MongoDB, which resides on a server such as Amazon EC2. In an embodiment, both the NoSQL and MySQL databases reside in a cloud-based web storage service such as Amazon's Web Service (AWS).

In an embodiment, when the tutor sends the invitation to a student, an entry on the invitation table in the MySQL database gets created which is assigned to those two parties. When a student subsequently accepts the invitation said session entry is updated with user data, date, and time. In the preferred embodiment, a student cannot accept the invitation if said student has not provided credit card other payment details. In the preferred embodiment, in order for a student to successfully book a session with a tutor, the student's credit card or selected payment option must be successfully processed. In an embodiment, a session entry and corresponding reservation will be prevented from being created in the event that the student has not entered payment details. These payment details include, but are not limited to a valid credit card number or other payment options. This inability to reserve a tutor, and corresponding checks on the back-end server, prevent students from booking resources without a financial commitment.

In an embodiment, once the student accepts the session invite sent over by the tutor, the then booked session with the unique session ID is saved to both the Student Homepage and the Tutor Homepage. The Student Homepage and the Tutor Homepage are a web page that the student and tutor respectively can view all upcoming online tutoring sessions. The server assigns the online tutoring session the appropriate filter to appear on the page either under “Upcoming Sessions” or “Sessions within 24 hours”. “Upcoming Sessions” are all tutoring sessions that are outside of 24 hours. All tutoring sessions that are within 24 hours are moved to under “Sessions within 24 hours”. All tutoring sessions that are within 24 hours have a join button next to it, which the student and tutor will be able to click on to join the online tutoring session once the agreed upon time for the tutoring session arrives.

In an embodiment, the utility cron is used for scheduling tasks to run on servers. In an embodiment, in addition to being used for automated system maintenance and administration, a cron is used to detect newly created sessions, which are about to start, and to process payments. Said cron job may run with a frequency of once per minute; hence, it will take a maximum of approximately 1 minute for users to see a session that has been newly assigned to them. If the session payment was successful then both users will be able to click on the join button to enter the online tutoring session.

In an embodiment, the join button is enabled a short period of time prior to the start of the session. In another embodiment, both parties can join the online tutoring session prior to the scheduled start. In another embodiment, one or more of the parties can see if the other party has joined prior to the start of the scheduled tutoring session. In another embodiment, at least one of the audio, video, or whiteboard technologies is disabled until the scheduled start of the tutoring session. This prevents students from extending the tutoring session by simply joining. The ability to see that the other party has joined in advance of the upcoming start time reassures the other party that the scheduled tutoring session will occur as scheduled. When either party clicks the join button, the validity of the session is queried from the MySQL database prior to enabling audio, video, or whiteboard services.

In an embodiment, online tutoring sessions are a program that are ran on a server, wherein the online tutoring session is comprised of at least one of the following; audio, video, whiteboard technology, screen sharing, instant message, and the ability to upload documents.

Data from the tutoring session, “Session data” is saved on a MySQL server, which is hosted on Amazon RDS. This information includes audio, video, and/or whiteboard technology that was shared in the online tutoring session which can be defined as Session data. The user data, which includes but is not limited to; user profile, account information, user name, user picture, user background information, gender, grade in school, is saved on a database. In the preferred embodiment, the user data is saved on MongoDB, which is hosted by Amazon EC2.

In an embodiment, credit card and/or other payment information may be on a secured third-party server such as Stripe. Use of a third party to handle payment information is more secure and decreases the liability of an online tutoring company.

In an embodiment, the whiteboard technology used by the website is Scribblar and the audio/video technology is provided by Twilio. In an embodiment, the audio/video is recorded by a third-party video service such as Twilio. Both of these programs are hosted on Amazon EC2. These outside services run inside the website program at the website program's initiation.

In an embodiment, by combining a plurality of audio, video, and/or whiteboard technology into an online tutoring session, tutors and students are able to have the following features during their online tutoring session; ability to upload lab assignments, ability to upload additional documents, ability to share documents in a “virtual classroom” setting between participants within the tutoring session, ability to annotate the virtual whiteboard, ability to edit shared documents in real time, verbally and visually communicate with session members, ability to screen share, and the ability to instant message session participants.

In an embodiment, once a student and tutor both join an online tutoring session the online tutoring session will begin to record. An online tutoring recording is comprised of at least one of the following; audio of what was said during the tutoring session, video of the tutor and/or student, video of the whiteboard technology which allows the student and tutor to upload an assignment, share an assignment, write on the virtual whiteboard, write on an uploaded assignment on the virtual whiteboard.

In an embodiment, once a student or tutor ends the online tutoring session the recording of the online tutoring session will end. In an embodiment, once the recording of the online tutoring session ends the recording may be saved in a way that allows the recorded online tutoring session to be accessible which can include but is not limited to; single file format, audio video Interleave (AVI), Flash Video Format (FLV), Apple Quicktime Movie (MOV), etc.

In an embodiment, after a recording of an online tutoring session is complete, the recording is saved to the MySQL database, which is hosted on a server such as Amazon Relational Database Service (RDS).

In an embodiment, a shareable link is generated by the My SQL database for the recording of each online tutoring session that corresponds to each sessions' specific ID. In an embodiment, once the server matches the correct student with the session ID of the online tutoring session, an email will be generated and sent to the email on file for said student. In an embodiment, the email that is sent to the student will include a link to the recorded online tutoring session. In an embodiment, the recording of an online tutoring session contains but is not limited to all session data including; audio of what was said during the session, video of the tutor, video of the student, video of the whiteboard technology, video of what was screen shared, any messages between the student and tutor, any documents that were uploaded, any documents that were worked on between the student and tutor, and any other transaction that occurred between the student and tutor through the online tutoring platform.

In an embodiment, the student is able to click on the link to view the recorded online tutoring session and the student will be able to download the recorded online tutoring session. Students are able to review the recorded online tutoring session for further review and understanding, and as a refresher later on. Students are able to also share the recorded online tutoring session with their parents who may or may not be able to be present. Enabling the students' parents to view the recording of said online tutoring session enables these parents to assess the effectiveness of the tutor, the appropriateness of the tutor, the effort of their child, and the material that was covered during the online tutoring session. In addition, to providing parents with the ability to review the recorded online tutoring sessions provides additional benefits including; a great review for test preparation, creating accountability on the part of the student knowing that his/her parent or parents may review the tutoring session to assess their level of engagement, provides accountability for the tutors on several levels. Knowing that the sessions are recorded discourages unprofessional behavior, encourages high effort, allowing parents to assess the appropriateness of the tutors behavior, allowing the tutoring company to assess the effectiveness of the tutors. In an embodiment, the tutors rankings are, in part, bases on the tutoring companies reviews of recorded tutoring sessions, provides a legal record of the tutoring session in the even that a dispute over whether the session occurred with respect to billing, and the recorded sessions my be mad available to the parents of the students by means of a link to the recording. The fact that the link is made avail tends to inspire higher effort on the part of the student.

In an embodiment, STEM Sensei employees will be able to have access to view all saved recorded online tutoring sessions that are saved in the MySQL database. By allowing employees of STEM Sensei to review recorded online tutoring sessions, the business is able to ensure that each tutor is abiding by the Code of Conduct and conducting each tutoring session in a professional manner, can ensure that each tutor has the requisite knowledge to assist the student, if a complaint is made the business can review the recorded online tutoring session and take appropriate actions. Recording online tutoring sessions and making them available to student, parents, and the business, a business is able to provide a safer higher quality service and can use these videos as training material to improve the quality of their tutors.

In an embodiment, a student can select to receive push notifications whenever a recorded online tutoring session is sent out. In an embodiment, some of the ways a student may receive notifications when a recorded online tutoring session is sent to them includes but is not limited to; electronic mail, short message service (SMS), and other instant message services. In an embodiment, a student will be able to select this option in his/her Student Dashboard Settings.

In an embodiment, parents of students can also select to receive push notifications whenever a recorded online tutoring session is sent out to the student. In an embodiment, some of the ways parents may receive notifications when a recorded online tutoring session is sent to their student includes but is not limited to; electronic mail, short message service (SMS), and other instant message services. In an embodiment, parents will be able to add the information needed to notify them on their client device by adding this information in the Student's Dashboard, which will be saved on the NoSQL database. By allowing parents to also receive notifications when a recorded online tutoring session is completed allows parents to have a better understanding of when their student is receiving tutoring and also helps ensure that parents know that they have the option to review the recorded online tutoring session for quality control purposes.

In an embodiment, an online tutoring service will be available where multiple students can join the same online tutoring session with one tutor. In an embodiment, a tutor can send multiple session invites to multiple students for the same online tutoring session. In an embodiment, when the student accepts the invitation, a session entry gets created using the data from both parties and takes into account the time on said entry. This session entry is specific to all parties involved, that is, the students and the tutor. In an embodiment, all students who have accepted the session invite from the tutor will be able to join the session within a set period of time prior to when the session is set to begin. In an embodiment, said tutor who has a session with students that have accepted his/her session invite will be able to join the session within a set period of time prior to when the session is set to begin.

The invention claimed is:

1. A system of online tutoring, comprising:
audio, video, and whiteboard technology for tutoring a student,
recording said audio, video, and whiteboard contents of the tutoring session,
storing the recorded tutoring session according to a policy,
the ability to review said recorded tutoring session at a later time.

2. The system of claim 1, wherein a recorded online tutoring session includes at least one of the following; audio between tutor and student, video of the student, video of the tutor, video of the material that was written on the whiteboard technology, video of uploaded documents, video of instant messages between tutor and student, and video of screen sharing

3. The system of claim 1, which additionally comprises the server that matches the session id of the recorded online tutoring session to the student's name and email address that is stored in the database hosted on the web hosting service.

4. The system of claim 3, which additionally comprises a student receiving a notification on a client device when he/she receives a link to the recording of the online tutoring session

5. The system of claim 1, wherein the ability to review a recorded online tutoring session at a later time additionally comprises enabling a student's parent to receive an electronic notification notifying the parent of a newly recording online tutoring session of his/her student.

6. The system of claim 5, which additionally comprises a link to the newly recorded online tutoring session

7. The system of claim 1, in which the ability to review said recorded tutoring session at a later time additionally comprises the student receiving the recording of said online tutoring session through email

8. A method of online tutoring, comprising:
audio, video, and whiteboard technology for tutoring a student,
recording said audio, video, and whiteboard contents of the tutoring session,
storing the recorded tutoring session according to a policy,
the ability to review said recorded tutoring session at a later time.

9. The method of claim 8, wherein a recorded online tutoring session includes at least one of the following; audio between tutor and student, video of the student, video of the tutor, video of the material that was written on the whiteboard technology, video of uploaded documents, video of instant messages between tutor and student, and video of screen sharing

10. The method of claim 8, which additionally comprises the server that matches the session id of the recorded online tutoring session to the student's name and email address that is stored in the database hosted on the web hosting service.

11. The method of claim 10, which additionally comprises a student receiving a notification on a client device when he/she receives a link to the recording of the online tutoring session

12. The method of claim 8, wherein the ability to review a recorded online tutoring session at a later time additionally comprises enabling a student's parent to receive an electronic notification notifying the parent of a newly recording online tutoring session of his/her student.

13. The method of claim 12, which additionally comprises a link to the newly recorded online tutoring session

14. The method of claim 8, in which the ability to review said recorded tutoring session at a later time additionally comprises the student receiving the recording of said online tutoring session through email
